(19) United States
(12) Patent Application Publication
(10) Pub. No.: US 2003/0030165 A1
(43) Pub. Date: Feb. 13, 2003

(54) Method and apparatus for extruding catheter tubing

(76) Inventors: Donald L. Centell, Pleasanton, CA (US); Lawrence C. Alpert, Fremont, CA (US)

Correspondence Address: GALLAGHER & KENNEDY, P. A., 2575 E. CAMELBACK RD. #1100, PHOENIX, AZ, 85016, US

(21) Appl. No.: 10/268,262

(22) Filed: Oct. 9, 2002

Related U.S. Application Data
(62) Division of application No. 09/430,327, filed on Oct. 29, 1999, now abandoned.

(51) Int. Cl. B29C 47/92

(52) U.S. Cl. 264/40.1

(57) ABSTRACT

Systems and methods for fabricating medical catheters are disclosed. A system in accordance with the present invention includes a first melt pump in fluid communication with an extrusion head, a second melt pump in fluid communication with the extrusion head, a puller arranged to receive extrudate emerging from the extrusion head, a first drive coupled to the first melt pump, a second drive coupled to the second melt pump, a third drive coupled to the puller, an encoder coupled to the third drive and being adapted to measure the length of extrudate passing through the puller, and a computer coupled to the first drive, the second drive, the third drive, and the encoder.

### RELATED REFERENCE TO RELATED APPLICATIONS

This is a divisional of application Ser. No. 09/430,326 filed Oct. 29, 1999 entitled “Method and Apparatus for Extruding Catheter Tubing,” priority from which is hereby claimed.

### FIELD OF THE INVENTION

The present invention relates generally to methods of manufacturing medical device tubing for devices such as catheters. More particularly, the present invention relates to an extrusion apparatus and method that allows control of varying material flow from multiple resin sources to a single head to form a single tubular member having improved dimensional stability.

### BACKGROUND OF THE INVENTION

Intravascular catheters are currently utilized in a wide variety of minimally invasive medical procedures. Generally, an intravascular catheter enables a physician to remotely perform a medical procedure by inserting the catheter into the vascular system of the patient at a location that is easily accessible and thereafter navigating the catheter to a desirable target site. By this method, virtually any target site in the patient's vascular system may be remotely accessed, including the coronary, cerebral, and peripheral vasculature.

Typically, the catheter enters the patient's vasculature at a convenient location such as a blood vessel in the neck or near the groin. Once the distal portion of the catheter has entered the patient's vascular system the physician may urge the distal tip forward by applying longitudinal forces to the proximal portion of the catheter. For the catheter to effectively communicate these longitudinal forces it is desirable that the catheter have a high level of pushability and kink resistance.

Frequently the path taken by a catheter through the vascular system is tortuous, requiring the catheter to change direction frequently. In some cases, it may even be necessary for the catheter to double back on itself. In order for the catheter to conform to a patient's tortuous vascular system, it is desirable that the intravascular catheter be very flexible, particularly in the distal portion.

While advancing the catheter through the tortuous path of the patient's vasculature, physicians often apply torsional forces to the proximal portion of the catheter to aid in steering the catheter. To facilitate the steering process, the distal portion of the catheter may include a plurality of bends or curves. Torsional forces applied on the proximal end must translate to the distal end to aid in steering. It is, therefore, desirable that the proximal portion of the intravascular catheter have a relatively high level of torqueability to facilitate steering.

The distance between the access site and the target site is often in excess of 100 cm. The inside diameter of the vasculature at the access site is often less than 5 mm. In light of the geometry of the patient's body, it is desirable to combine the features of torqueability, pushability, and flexibility into a catheter which is relatively long and has a relatively small diameter. Tight control of dimensional tolerances is critical to minimizing outside diameters, while maximizing catheter lumen diameters. Tight control of outside diameters allows access to smaller vessels, while maximizing inside diameter to allow passing of adequate fluids or other treatment devices. Further, while minimizing outside diameter and maximizing lumen diameter, it is necessary to maintain adequate wall thickness for the catheter to perform with necessary kink resistance, burst pressure, trackability and torqueability. Thus, it is highly desirable to have high dimensional stability in wall thickness.

After the intravascular catheter has been navigated through the patient's vascular system so that its distal end is adjacent the target site, the catheter may be used for various diagnostic and/or therapeutic purposes. One example of a diagnostic use for an intravascular catheter is the delivery of radiopaque contrast solution to enhance fluoroscopic visualization. In this application, the intravascular catheter provides a fluid path leading from a location outside the body to a desired location inside the body of a patient. In order to maintain a fluid path, it is desirable that intravascular catheters be sufficiently resistant to kinking. In addition, because such fluids are delivered under pressure, it is also desirable that intravascular catheters be sufficiently resistant to bursting or leaking.

One additional example of a useful therapeutic application of intravascular catheters is the treatment of intracranial aneurysms in the brain. An aneurysm which is likely to rupture, or one which has already ruptured, may be treated by delivering an embolic device to the interior of the aneurysm. One commonly used embolic device comprises a tiny coil of wire. When treating an aneurysm with the aid of an intravascular catheter, the catheter tip is typically positioned proximate the aneurysm site. The embolic device is then urged through the lumen of the intravascular catheter and introduced into the aneurysm. It is desirable that an intravascular catheter utilized in this procedure have the above-described performance features to reach and treat an aneurysm.

As described at length above, it is desirable to combine a number of performance features in an intravascular catheter. It is desirable that the catheter have a relatively high level of pushability and torqueability, particularly near its proximal end. It is also desirable that a catheter be relatively flexible, particularly near its distal end. It is further desirable that dimensional tolerances are kept under tight control to maintain adequate wall thickness, while minimizing outside diameter and maximizing lumen diameter.

Co-extrusion is one method which may be utilized to build a catheter having a combination of performance functions. A co-extrusion process generally involves the extrusion of a catheter from a plurality of materials. Co-extrusion is taught in a number of U.S. Patents including U.S. Pat. No. 5,725,814 to Harris, entitled Extrusion of an Article of Varying Content; U.S. Pat. No. 5,622,665 to Wang, entitled Method for Making Tubing; and U.S. Patent No. 5,542,937 to Chee, entitled Multilumen Extruded Catheter.

With prior art co-extrusion processes, individual extruders feed differing materials to a single extrusion head. The extradite from the extrusion head forms a single tubular member. An example of a co-extruded product is a tube extruded by a pair of extruders feeding a co-extrusion die that directs a first material to the outside of the extruded tube and directs a second material to the inside of the tube. The result is a coaxial two-layer tubular extrusion. In contrast, Wang teaches varying quantities of a first and second co-extruded material to make differential stiffness tubing. By varying the amount of a first polymer and a second polymer, Wang teaches making a proximal stiff section made entirely from a first polymer, a distal more flexible section made entirely from a second polymer and a transition section that includes both polymers in varying amounts over its length. The transition section thus transitions from stiff to flexible over its length.

Harris teaches that co-extrusion systems having extruders directly connected to co-extrusion dies yield less than optimum results. The amount of plastic which comes out the exit of an extruder is not exactly proportional to the speed of the screw. The throughput varies with the viscosity of the plastic, the pressure at the die, and other variables. If one varies the speeds of the extruders of a co-extrusion system, one theoretically varies the amount of each of the materials in the extrudate. However, with extruders, this variation cannot be precisely controlled, and it is virtually impossible to change relatively quickly from one material to the other or to vary the content so that the extrudate changes gradually in a precisely controlled fashion from one material to another. One reason for this is that the extruder is subject to considerable “drool.” If an extruder screw is stopped, there is still a great deal of plastic that can come out of the grooves of the screw.

Harris teaches that when extruders are used for the above-mentioned scheme for varying the material content along the length of the extrudate, there are several problems:

a. The inertia of the screw, motor, gearbox system in an extruder is high. It is consequently very difficult to control the speed accurately or quickly.

b. The output of an extruder is not linear with speed, so it is not possible to predict what the total output from two or more extruders will be.

c. The drool from the extruders will distort the control of the percentages of each material.

d. Since the extruders react on each other through the back pressure created in the die, the output of each extruder is affected not only by what happens in that extruder, but also by what happens in all of the others. Hence, if one attempts to deliver more material from one extruder by increasing its speed, the pressure at the die increases, not just for that extruder, but for all others, reducing their output.

One way to change from one extrudate material to another is the use of a valve to effect the change. The valve allows one material to go into the die, while the other is diverted and discarded in the scrap bin. The two flows can then be reversed and an extrudate varying in content results. Obviously, that system is extremely wasteful.

An apparatus taught by Harris includes a first extruder connected with a first gear pump and a second extruder connected with a second gear pump. A co-extrusion die receives the output of the two gear pumps. A first controller, which may be a Harrel, Incorporated CP-871 DIGIPANEL extrusion controller, controls, the temperature along the barrel of the first extruder and controls the speed of a screw drive motor that drives a screw of the first extruder. A second controller controls the temperature along the barrel of the second extruder, and controls the screw drive motor that drives the screw of the second extruder. The first gear pump is driven by a first servo-motor controlled by the first controller, and likewise the second gear pump is driven by a second servo-motor controlled by the first controller. A conventional puller pulls the extrudate through a water trough and past a laser gauge. A drive motor of the puller is under the control of the first controller.

A co-extrusion of two materials that changes from one material to another along its length may be produced with the Harris system by ramping-up the first gear pump, while ramping-down the second gear pump.

### SUMMARY OF THE INVENTION

The present invention relates generally to methods of manufacturing medical devices. More particularly, the present invention relates to methods of fabricating rod and catheter tubing especially suitable for intravascular catheter procedures. Although only catheter tubing is described in detail, all characteristics and processes may be similarly related to the alternative embodiment of fabricated rod.

Tubing which is especially suitable for intravascular catheter procedures includes performance characteristics which were previously disclosed. The tubing preferably includes a proximal portion which is stiffer, a distal portion which is more flexible, and a transition region therebetween. This tubing is manufactured, in the present invention, utilizing a co-extrusion apparatus which includes multiple (at least two) sources of different polymeric material which are fed from extruders to a single extrusion head. The relative proportions of each polymer are varied over the length of the catheter tubing to achieve desired performance characteristics. Thus, in preferred embodiments, the apparatus for manufacturing catheter tubing feeds essentially 100% of the first stiffer polymeric material to the extrusion head to form the proximal portion of a catheter shaft, and feeds essentially 100% of a second polymeric material, which is more flexible, to the extrusion head to form the more flexible distal portion of a catheter shaft. The process forms a transition region or length of transition tubing between the proximal and distal portions which includes a varying amount of both the stiff and flexible polymer by ramping up or down relative proportions of such polymers being fed to the extrusion head. For example, the extrusion head may be fed 100% of a stiff polymer, and at the point of transition, the amount of the first polymer being fed to the extrusion head may be tapered off, while simultaneously turning on and increasing the amount of the second polymer being fed to the extrusion head over a specified length of the catheter until the flow of the first polymeric material is zero and the distal portion of the catheter is then formed by the 100% flow of the second polymeric material.

Although the above-identified process produces tubing having the performance characteristics desired in a catheter tubing, a further requirement for tubing which is especially suitable for intravascular catheter procedures is that the tubing have tight tolerances on dimensions, including inside diameter, outside diameter and wall thickness. Tight tolerances on dimensions for tubing that is used in intravascular catheters are critical so that the tubing may be utilized to access remote vessels, while being useful for the treatment procedures once at the site. Therefore, it is preferred that the outside diameter of the tubing be minimized and consistent so that a selected catheter is assured to fit within vessels of expected diameter. Further, it is preferable that the inside diameter be as large as possible so that adequate fluid may be passed through the lumen or other treatment devices may be passed through the lumen. Thus, the wall thickness should be minimized, yet maintained thick enough to provide the above performance characteristics. Therefore, it is critical that as the wall thickness is minimized, there must be tight control on tolerances within the wall thickness to provide a consistent large lumen and consistent performance characteristics over the length of the tubing. In general, it is necessary that dimensional tolerances be about 0.0005 inches to about 0.001 inches for the inside and outside diameters of the tubing to be utilized in an intravascular catheter. The apparatus and method to achieve such dimensional stability is disclosed in summary below.

A catheter forming system in accordance with the present invention includes an extrusion head which is in fluid communication with a plurality of melt pumps. Each melt pump is in fluid communication with a material source such as an extruder. The plurality of melt pumps are each adapted to selectively pump materials from one of the plurality of material sources into the extrusion head. The material pumped into the extrusion head is expelled from the extrusion head and forms an extrudate member.

A cooling trough is preferably disposed proximate the extrusion head. The cooling trough is adapted to receive the extrudate member as it emerges from the extrusion head. A puller is disposed proximate the cooling trough and is adapted to receive the extrudate member as it exits the cooling trough. When the extrudate member exits the puller, it passes through a cutter which is disposed proximate the puller. The cutter is adapted to selectively cut the extrudate member into lengths. A conveyor is adapted to receive the lengths and transfer them in a distal direction.

The system includes a plurality of drives. The first melt pump is driven by a first drive having a first encoder, or equivalent device. The second melt pump is driven by a second drive having a second encoder, or equivalent device. The puller is driven by a puller drive having a puller encoder, or equivalent device. The cutter is driven by a cutter drive having a cutter encoder, or equivalent device. The first drive, the second drive, the puller drive, and the cutter drive are all coupled to a drive controller. The drive controller is coupled to a motion control unit. The drive controller and the motion control unit are both coupled to a computer. In a presently preferred embodiment, the computer comprises a personal computer including a microprocessor. A monitor, a keyboard, and a mouse may each be selectively coupled to the computer.

The system also includes a pressure controller which is in fluid communication with both an air supply and the extrusion head. The pressure controller is coupled to the computer via the I/O unit. The pressure controller is adapted to control the pressure inside a lumen defined within the extrusion head to form a lumen of the extrudate member. A control signal generated by the computer and the I/O unit may be used to select a target pressure for the pressure controller.

To achieve the necessary tolerances with the above apparatus, Applicants have devised a control system which allows for responding to the dynamics of material flow through the extrusion process to achieve dimensional stability, while the amount of material from each melt pump is varied.

Applicants have found that the dynamics of the above system are complex, and linear ramping of melt pump speeds cannot produce tubing of adequate dimensional stability. The present invention, therefore, includes means for controlling the individual pump speeds over a cycle of ramping the pump speed up or down that functions from a velocity profile for that pump over a single cycle up or down. The velocity profile includes non-linear curved portions which correspond to pump speed at a given length of tube extruded that are experimentally developed to match the materials being extruded and the system utilized.

Applicants have found that resins, even those that are specified as being the same product, actually extrude differently due to variations within the resin, such as moisture content. Further, Applicants have found that as gear pumps increase in velocity from near zero, it is necessary to compensate for an initial surge in material due to the pressure behind the gear pump and compression of the material within the gears. The concept would be analogous to packing a material within a measuring cup prior to using such material. Further, Applicants have found that as a melt pump ramps up to a maximum speed for a cycle, it is necessary to taper the rate of speed increase near its final speed to prevent overshoot on the upper end which creates flaws in the dimensions of the tubing. Another source of identified dimensional variability is simply due to the construction of the extrusion head, wherein each material enters the extrusion head at a different point, and therefore, a different velocity profile is necessary for material entering each point on the extrusion head. Finally, it has been found that different polymeric materials require a different velocity profile to achieve the same/product. Thus, a velocity curve for a hard material is different from that for a soft material when maintaining dimensional stability.

It is contemplated that the present invention may be implemented in either software or hardware, or a combination thereof. In a presently preferred embodiment, the computer is programmed to direct the system in performing a plurality of steps in accordance with the present invention. In a presently preferred embodiment, the program runs in conjunction with a WINDOWS NT operating system, and the program includes a graphical user interface (GUI). The operator may perform some operations such as opening files using procedures which are similar to the procedures used by other programs which run in WINDOWS NT. This provides operating ease with a minimum of training, and takes advantage of the existing WINDOWS NT operation system structure. The computer program may be called up by using the mouse to double click on the program icon. When the program is initialized, a Manual Control screen will appear on monitor.

A first melt pump profile may be entered into the computer, wherein the first melt pump profile is comprised of a plurality of desired first melt pump rotational velocity values over a single ramping cycle up or down and each value is paired with an extrusion distance value. A second melt pump profile may be entered into the computer, wherein the second melt pump profile is comprised of a plurality of desired second melt pump rotational velocity values over a single ramping cycle up or down and each value is paired with an extrusion distance value.

A puller profile may be entered into the computer, wherein the puller profile is comprised of a plurality of desired pulling velocity values each paired with an extrusion distance value. The process of extruding material from the extrusion head may be initiated with a click of the mouse. An extrudate member is formed, and the distance of the extrudate member passing through the puller is measured.

The desired first melt pump rotational velocity value corresponding to the measured extrusion distance value in the first melt pump rotational velocity profile is determined, and the speed of the first melt pump is adjusted by the first melt pump drive so that it is substantially equal to the desired first melt pump rotational velocity value. The desired second melt pump rotational velocity value corresponding to the measured extrusion distance value in the second melt pump rotational velocity profile is determined, and the speed of the second melt pump is adjusted so that it is substantially equal to the desired second melt pump rotational velocity value.

The desired pulling velocity value corresponding to the measured extrusion distance value in the pulling velocity profile is determined, and the speed of the puller is adjusted by the puller drive so that it is substantially equal to the desired pulling velocity value.

### BRIEF DESCRIPTION OF THE DRAWINGS

FIG. 1 is a block diagram of a catheter forming system including an extrusion head in fluid communication with a first melt pump and a second melt pump, each melt pump being in fluid communication with an exemplary embodiment of a material source;

FIG. 2 is an illustration of a manual control screen which may be utilized in one method in accordance with the present invention;

FIG. 3 is an illustration of profile editor screen which may be utilized to create profiles for melt pump rotational velocity, pulling speed, and other parameters in a method in accordance with the present invention;

FIG. 4 is an illustration of a synchronous control screen which may be utilized to run a plurality of parameter profiles in accordance with the present invention;

FIG. 5 is a block diagram of an additional embodiment of a catheter forming system including an extrusion head in fluid communication with a plurality of melt pumps, each melt pump being in fluid communication with an additional exemplary embodiment of a material source;

FIG. 6 is a cross-sectional view of an exemplary embodiment of a material source in accordance with the present invention; and

FIG. 7 is a perspective view of an additional exemplary embodiment of a material source in accordance with the present invention.

### DETAILED DESCRIPTION OF THE INVENTION

The following detailed description should be read with reference to the drawings, in which like elements in different drawings are numbered identically. The drawings, which are not necessarily to scale, depict selected embodiments and are not intended to limit the scope of the invention. Examples of constructions, materials, dimensions, and manufacturing processes are provided for selected elements. Those skilled in the art will recognize that many of the examples provided have suitable alternatives which may be utilized.

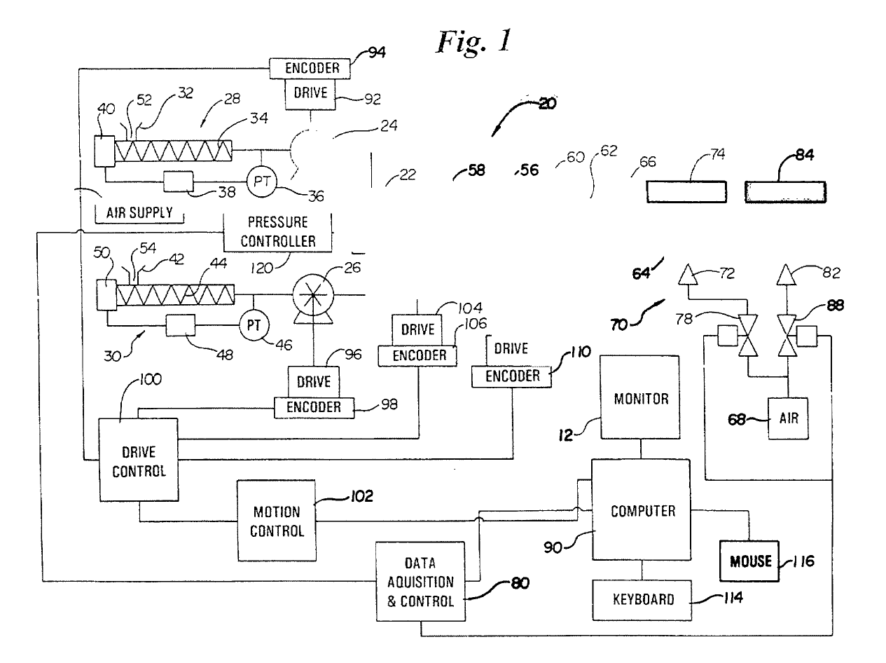

FIG. 1 is a block diagram of a catheter forming system 20. System 20 includes an extrusion head 22 in fluid communication with a first melt pump 24 and a second melt pump 26. First melt pump 24 is in fluid communication with a first material source 28. Second melt pump 26 is in fluid communication with a second material source 30. In the embodiment of FIG. 1, first material source 28 includes a first hopper 32, a first screw 34, a first pressure transmitter 36, a first screw controller 38, and a first motor 40. In a similar manner, second material source 30 includes a second hopper 42, a second screw 44, a second pressure transmitter 46, a second screw controller 48, and a second motor 50. First motor 40 and second motor 50 are adapted to drive first screw 34 and second screw 44 respectively. Embodiments of first material source 28 and second material source 30 other than those shown in FIG. 1 have been contemplated.

First material source 28 is described in more detail below. Second material source 30 is substantially similar to first material source 28. In the embodiment of FIG. 1, first pressure transmitter 36, first screw controller 38, and first motor 40 comprise a control loop. First pressure transmitter 36 detects the pressure proximate the outlet of first screw 34. First screw controller 38 adjusts the speed of first motor 40 so that the pressure detected by first pressure transmitter is within a predetermined desirable range.

A first material 52 may enter first material source 28 via first hopper 32. First screw 34 transfers first material 52 to the outlet of the screw. First material 52 from first material source 28 is pumped into extrusion head 22 by first melt pump 24. Likewise, a second material 54 from second material source 30 is pumped into extrusion head 22 by second melt pump 26. In a presently preferred embodiment, first melt pump 24 and second melt pump 26 are positive displacement pumps. First material 52 and/or second material 54 may be selectively expelled from extrusion head 22 to form an extrudate member 56. It should be understood that system 20 may include additional material sources, and additional melt pumps without deviating from the spirit and scope of the present invention. It has been contemplated that extrudate member 56 may be comprised of a plurality of materials.

A cooling trough 58, or other forming device, is disposed proximate extrusion head 22. Cooling trough 58 is adapted to receive extrudate member 56 as it emerges from the extrusion head 22. A puller 60 is disposed proximate cooling trough 58 and is adapted to receive extrudate member 56 as it exits cooling trough 58.

When extrudate member 56 exits puller 60, or similar hauling device, it may pass through a cutter 62 which is disposed proximate puller 60. Cutter 62 is adapted to selectively cut extrudate member 56 into lengths 64. A conveyor 66 is adapted to receive lengths 64 and transfer them in a distal direction.

An offloading system 70 is disposed proximate conveyor 66. In the embodiment of FIG. 1, offloading system 70 includes a first blow off nozzle 72, a first bin 74, and a first valve 78. As shown in FIG. 1, first blow off nozzle 72 and first bin 74 are disposed on opposite sides of conveyor 66. A fluid, for example air, may be selectively expelled from first blow off nozzle 72 by opening first valve 78. The fluid emerges from first blow off nozzle 72 with a velocity which is sufficient to knock lengths 64 off of conveyor 66 and into first bin 74. Offloading system 70 also includes a second blow off nozzle 82, a second bin 84, and a second valve 88. Second blow off nozzle 82 is arranged to knock lengths 64 into second bin 84.

In a presently preferred embodiment, first valve 78 and second valve 88 are solenoid valves which are in fluid communication with a source of compressed air 68. First valve 78 and second valve 88 are each coupled to a computer 90 via an I/O unit 80. I/O unit 80 and computer 90 are adapted to selectively actuate first valve 78 and second valve 88. Those of skill in the art will appreciate that other embodiments of offloading system 70 are possible without deviating from the spirit and scope of the present invention. For example, embodiments of offloading system 70 have been envisioned which include a plurality of valves arranged to selectively provide fluid flow to a plurality of nozzles.

As shown in FIG. 1, first melt pump 24 is driven by a first drive 92 having a first encoder 94, or equivalent device. First drive 92 and first encoder 94 are coupled to a computer via a drive controller 100 and a motion control unit 102. In a presently preferred embodiment, drive controller 100 comprises a NUDRIVE Servo Controller available from National Instruments of Austin, Texas. Also in a presently preferred embodiment, motion control unit 102 comprises a FLEXMOTION Four Axis Controller available from National Instruments of Austin, Texas. Those of skill in the art will appreciate that drive controller 100 and motion control unit 102 may be comprised of other elements without deviating from the spirit and scope of the present invention.

As shown in FIG. 1, system 20 includes a plurality of additional drives. Second melt pump 26 is driven by a second drive 96 having a second encoder 98, or equivalent device. Puller 60 is driven by a puller drive 104 having a puller encoder 106, or equivalent device. Cutter 62 is driven by a cutter drive 108 having a cutter encoder 110, or equivalent device. Second drive 96, puller drive 104, and cutter drive 108 are all coupled to drive controller 100.

Drive controller 100 and motion control unit 102 are both coupled to a computer 90. In a presently preferred embodiment, computer 90 comprises a personal computer including a microprocessor. A monitor 112, a keyboard 114, and a mouse 116 may each be selectively coupled to computer 90.

It is contemplated that the present invention may be implemented in either software or hardware, or a combination thereof. In a presently preferred embodiment, computer 90 is programmed to direct system 20 to perform a plurality of steps in accordance with the present invention. In a presently preferred embodiment, the program runs in conjunction with a WINDOWS NT operating system, and the program includes a graphical user interface (GUI). The operator may perform some operations such as opening files using procedures which are similar to the procedures used by other programs which run in WINDOWS NT. This provides operating ease with a minimum of training, and takes advantage of the existing WINDOWS NT operation system structure.

System 20 also includes a pressure controller 120 which is in fluid communication with both an air supply 118 and extrusion head 22. Pressure controller 120 is coupled to computer 90 via I/O unit 80. Pressure controller 120 is adapted to control the pressure inside a lumen defined by extrudate member 56. A control signal generated by computer 90 and I/O unit 80 may be used to select a target pressure for pressure controller 120. In a presently preferred embodiment, the control signal is a variable voltage signal, and pressure controller 120 is adapted to vary pressure in response to variations in the voltage of the signal. This may be accomplished in a non-linear fashion.

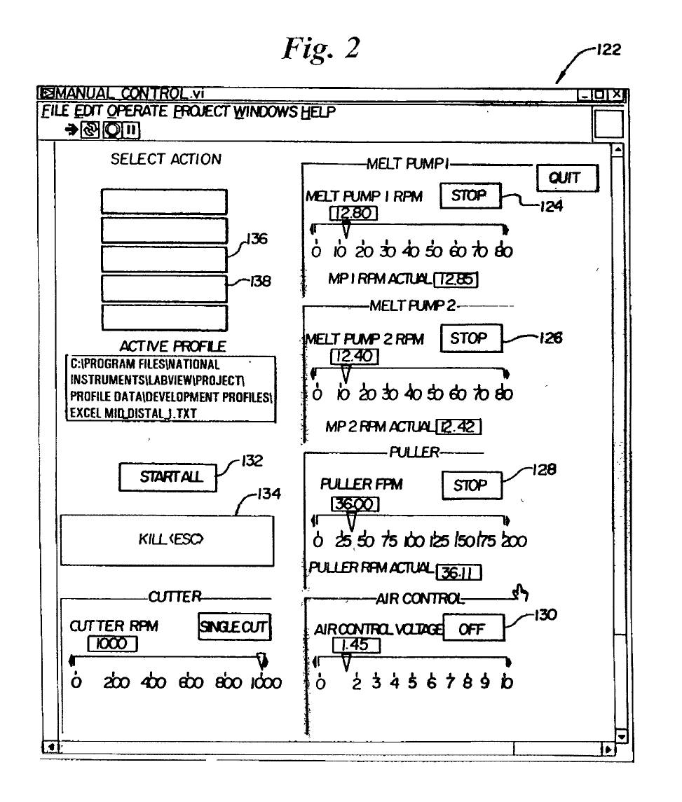

FIG. 2 is an illustration of a manual control screen 122 of the present invention. Manual control screen 122 displays values for melt pump 1 RPM, melt pump 2 RPM, Puller FPM, Air Control Value, and Cutter RPM. To promote clear communication, the values for melt pump 1 RPM, melt pump 2 RPM, Puller FPM, Air Control Value, and Cutter RPM may be referred to collectively as axes.

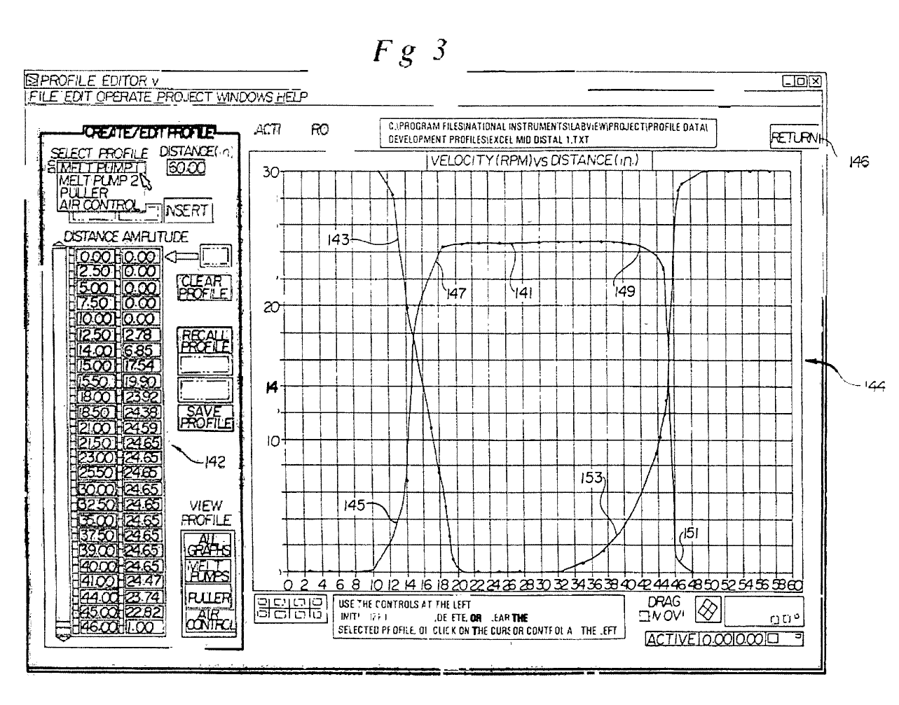

A system user may selectively start and stop) any axes by actuating the corresponding start/stop buttons 124, 126, 128, 130 in manual control screen 122. All axes may also be started concurrently by actuating a start all key 132. Actuating kill button 134 stops all axes concurrently. Manual control screen 122 also includes a run synchronous control button 138, and a profile editor button 136 which may be actuated to access a profile editor screen 140 (the profile editor screen is depicted in FIG. 3). Profile editor screen 140 may be utilized to enter a desired profile for each axis.

FIG. 3 is an illustration profile editor screen 140 which may be utilized to create profiles for melt pump rotational velocity, pulling speed, and other parameters in a method in accordance with the present invention. Profile editor screen 140 includes a table 142, a graph 144, and a return button 146. A profile may be created by entering values in table 142 using keyboard 114 and/or mouse 116. A profile may also be drawn on graph 144 using mouse 116.

The graphs in FIG. 3 depict a key feature of the present invention which provides for achieving required tolerances and dimensional stability in tubing manufactured for intravascular catheters with the above-described system. In particular, graph 144 depicts a first melt pump velocity profile 141 and a second melt pump velocity profile 143 as a function of distance or length of tubing manufactured. The graph 144 depicts a single cycle for the two melt pumps, wherein the first melt pump is ramped in a non-linear fashion from zero to a high of about 24.5 and then back down to zero, while the second melt pump is ramped from a high of 30 to zero and back up to 30 during the same cycle. The non-linear velocity profile curves translate to differing rates of acceleration and deceleration of the melt pumps through the single cycle which compensate for the dynamics of the extrusion system so that tubing of adequate dimensional stability is manufactured.

In following the velocity profile of the first melt pump 141, it is particularly noted that the non-linear portions of the profile can be utilized to compensate for many different variables within the system. For example, in the first portion of the curve, as indicated at 145, the melt pump is being ramped up from zero in a non-linear fashion that compensates for compaction of material within the positive displacement pump and behavior of that material as it enters the extrusion head. Further, as the speed of the first melt pump approaches its maximum in the cycle, a non-linear deceleration, as indicated on the graph at 147, is included to prevent overshooting the desired quantity of that material delivered to the extrusion head. Again, as indicated on the profile for the first melt pump at 149, the first melt pump is decelerated in a nonlinear fashion to achieve desired flow rate of that material through the extrusion head and maintain dimensional stability. Finally, as indicated at 151, the final portion of the cycle for melt pump 1 includes non-linear deceleration to zero to smooth the transition to no flow of the first material through the extrusion head.

Now looking in detail at the velocity profile for the second melt pump over a single cycle, it can be readily seen that such cycle is not a mirror image of the first melt pump velocity profile 141. For example, in portion 153 where the second melt pump ramps up from zero, a different non-linear profile is utilized to compensate for the dynamics of flow of that particular material to the extrusion head. The material will be flowing to a different portion of the extrusion head, and thus, will behave in a different fashion with respect to flow therethrough. Further, a second material will have differing physical properties, and thus different degrees of compaction within the gear pump when the rotation is at zero.

With the infinite combinations of velocity profiles for the two materials utilized in the differing melt pumps, Applicants' system can be utilized to compensate for all of the dynamics which may be present. Experimental runs of the combination of materials may be utilized to fine tune expected velocity profiles in order to maintain dimensional stability for a single run of materials.

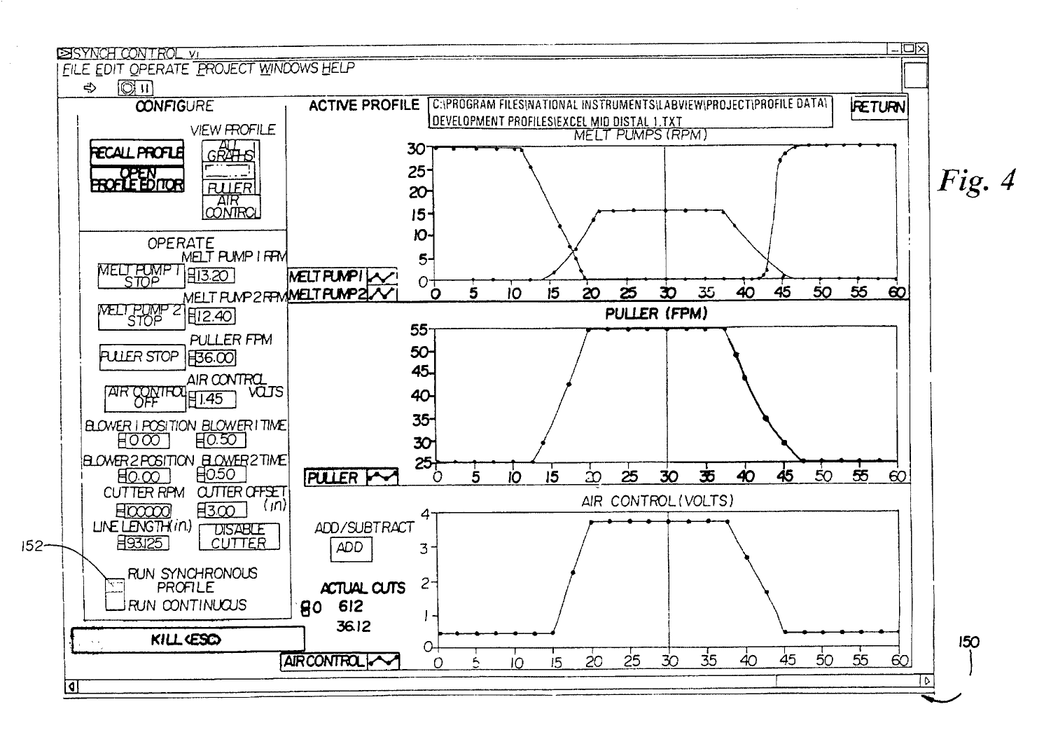

FIG. 4 illustrates a synchronous control screen 150. Synchronous control screen 150 includes a slide 152 which allows the system user to choose between “Run Synchronous Profile” , and “Run Continuous” . When synchronous control screen 150 is initiated, the default mode is “Run Continuous.” In this mode the values from manual control screen 122 are automatically entered for each axis, and each axis remains running at those values. When slide 152 is set to the “Run Synchronous Profile” mode, the system will begin running the profile for each axis. In a presently preferred embodiment, each profile will repeat itself in a continuous loop. Therefore, it is desirable that the starting value for each profile be equal to that profile's ending value.

It may be appreciated from the above description, that system 20 is capable of synchronizing the rotational velocity of the first melt pump with the extrusion distance value measured utilizing the puller encoder. Likewise, system 20 is capable of synchronizing the rotational velocity of the second melt pump with the extrusion distance value measured utilizing the puller encoder. Additionally, system 20 is capable of synchronizing the puller speed with the extrusion distance value measured utilizing the puller encoder. System 20 is also capable of synchronizing the air control voltage with the extrusion distance value measured utilizing the puller encoder.

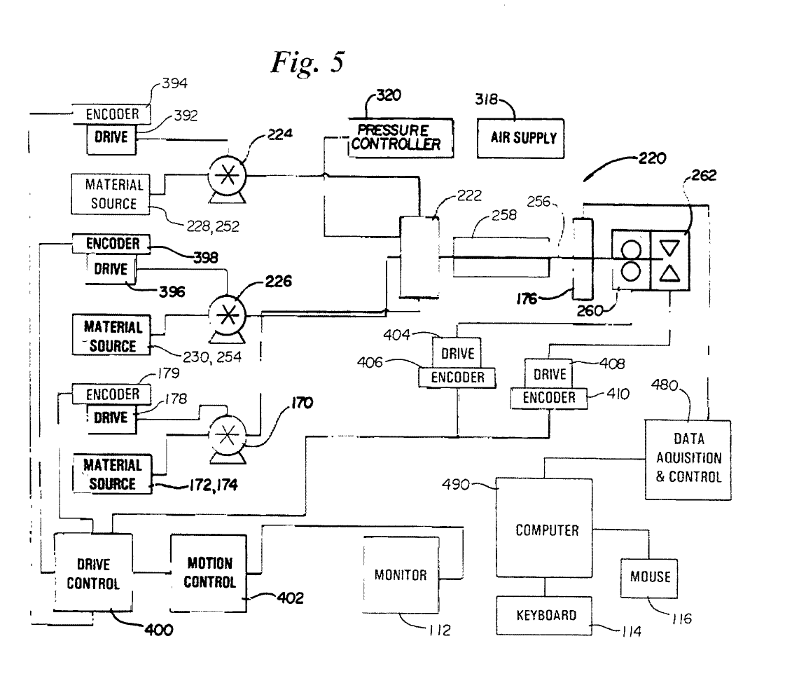

FIG. 5 is a block diagram of an additional embodiment of a catheter forming system 220 in accordance with the present invention. System 220 includes an extrusion head 222 which is in fluid communication with a first melt pump 224, a second melt pump 226, and a third melt pump 170. First melt pump 224 is in fluid communication with a first material source 228 containing a first material 252. Second melt pump 226 is in fluid communication with a second material source 230 containing a second material 254. Third melt pump 170 is in fluid communication with a third material source 172 containing a third material 174. Many embodiments of first material source 228, second material source 230, and third material source 172 have been contemplated.

First material 252, second material 254, and third material 174 may each be selectively expelled from extrusion head 222 to form an extrudate member 256. It should be understood that system 220 may include additional material sources and additional melt pumps without deviating from the spirit and scope of the present invention. It has been contemplated that extrudate member 256 may be comprised of a plurality of materials.

A cooling trough 258, or other forming device, is disposed proximate extrusion head 222. Cooling trough 258 is adapted to receive extrudate member 256 as it emerges from the extrusion head 222. A gauge 176 is disposed about extrudate member 256 proximate cooling trough 258. Gauge 176 is adapted to measure physical parameters of extrudate member 256. Examples of physical parameters which may be measured include outer diameter, inner diameter, and wall thickness. In a presently preferred embodiment, gauge 176 is a laser gauge. In the embodiment of FIG. 5, gauge 176 is coupled to a computer 490 via I/O unit 480.

A puller 260, or similar hauling device, is disposed about extrudate member 256 proximate gauge 176. Puller 260 is adapted to receive extrudate member 256 as it exits cooling trough 258. When extrudate member 256 exits puller 260, it may pass through a cutter 262 which is disposed proximate puller 260. Cutter 262 is adapted to selectively cut extrudate member 256 into lengths.

As shown in FIG. 5, first melt pump 224 is driven by a first drive 392 having a first encoder 394, or equivalent device. First drive 392 and first encoder 394 are coupled to a computer via a drive controller 400 and a motion controller 402. In a presently preferred embodiment, drive controller 400 comprises a NUDRIVE Servo Controller available from National Instruments of Austin, Texas. Also in a presently preferred embodiment, motion control unit 402 comprises a FLEXMOTION Four Axis Controller available from National Instruments of Austin, Texas. Those of skill in the art will appreciate that drive controller 400 and motion control unit 402 may be comprised of other elements without deviating from the spirit and scope of the present invention.

As shown in FIG. 5, system 220 includes a plurality of drives. Second melt pump 226 is driven by a second drive 396 having a second encoder 398, or equivalent device. Third melt pump 170 is driven by a third drive 178 having a third encoder 179, or equivalent device. Puller 260 is driven by a puller drive 404 having a puller encoder 406, or equivalent device. Cutter 262 is driven by a cutter drive 408 having a cutter encoder 410, or equivalent device. Second drive 396, Puller drive 404, and cutter drive 408 are all coupled to drive controller 400.

System 220 also includes a pressure controller 320 which is in fluid communication with both air supply 318 and extrusion head 222. Pressure controller 320 is coupled to computer 490 through I/O unit 480. Pressure controller 320 is adapted to control the pressure inside a lumen defined by extrudate member 256. A control signal generated by computer 490 and I/O unit 480 may be used to select a target pressure for pressure controller 320. In a presently preferred embodiment, the control signal is a variable voltage signal and pressure controller 320 is adapted to vary pressure in response to variations in the voltage of the signal. This may be accomplished in a non-linear fashion.

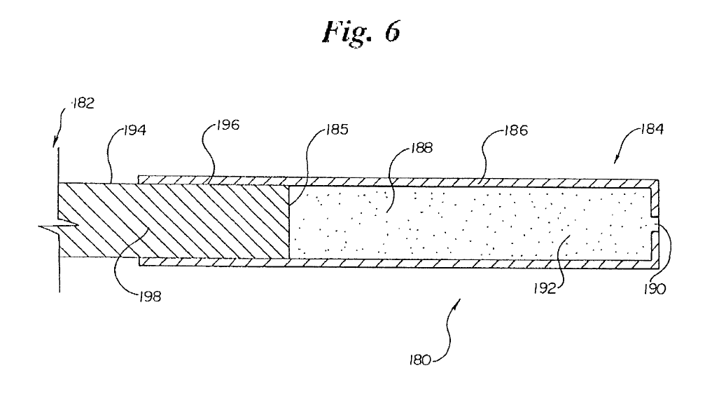

FIG. 6 is a cross-sectional view of an exemplary embodiment of a material source 180 having a proximal end 182 and a distal end 184. Material source 180 includes a plurality of walls 186 defining a chamber 188 and a port 190. A material 192 is disposed within chamber 188. Material 192 may be comprised of any material. In a presently most preferred method, material 192 is a thermoplastic material. Examples of thermoplastic materials which may be suitable in some applications include: polyethylene (PE), polypropylene (PP), polyvinylchloride (PVC), polyurethane, polytetrafluoroethylene (PTFE), and polyether block amide (PEBA). It has also been contemplated that methods and devices of the present invention may be utilized to form thermoset materials. Material source 180 also includes a ram 194 having a distal end 185, an elongate body 198, and a proximal end 183 (not shown). In FIG. 6, distal end 185 is disposed within chamber 188 defined by walls 186. A seal 196 is formed between chamber 188 and ram 194. In a method in accordance with the present invention, material 192 may be urged through port 190 by applying a force F to ram 194, urging it toward distal end 184 of material source 180. Many methods of applying force F to ram 194 are possible without deviating from the spirit and scope of the present invention. For example, ram 194 may be coupled to a hydraulic cylinder. By way of a second example, a leadscrew mechanism including a leadscrew and an electric motor may be coupled to ram 194.

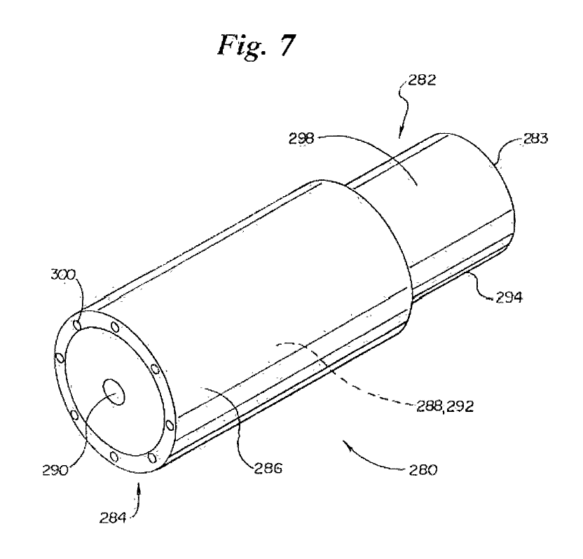

FIG. 7 is a perspective view of an additional exemplary embodiment of a material source 280 having a proximal end 282 and a distal end 284. Material source 280 includes a plurality of walls 286 defining a chamber 288 and a port 290. A material 292 is disposed within chamber 288. Walls 286 of material source 280 also define a plurality of heater lumens 300. In one embodiment of the present invention, a cartridge heater may be disposed within each heater lumen 300. In another embodiment of the present invention, the plurality of cartridge heaters are adapted to maintain material 292 at a desirable temperature. Cartridge heaters which may be suitable in some applications are commercially available from Watlow Incorporated of St. Louis, Mo.

Material source 280 also includes a ram 294 having a distal end 285 (not shown), an elongate body 298, and a proximal end 283. In FIG. 7, distal end 285 is disposed within chamber 288 defined by walls 286. A seal is formed between chamber 288 and ram 294. In a method in accordance with the present invention, material 292 may be urged through port 290 by applying a force to ram 294, urging it toward distal end 284 of material source 280.

Having described the Figures, a method of forming extrudate member 56 may be described with reference FIGS. 1-4. A method in accordance with the present invention may begin with the step of loading a first material into first hopper 32 of first material source 28. Likewise, a second material 54 may be loaded into second hopper 42 of second material source 30.

First material 52 and second material 54 may be comprised of any material. In a presently most preferred method, first material 52 and second material 54 are thermoplastic materials. Examples of thermoplastic materials which may be suitable in some applications include: polyethylene (PE), polypropylene (PP), polyvinylchloride (PVC), polyurethane, polytetrafluoroethylene (PTFE), and polyether block amide (PEBA). It has also been contemplated that methods and devices of the present invention may be utilized to form thermoset materials.

In a presently preferred embodiment of the present invention, first material 52 and second material 54 are comprised of PEBA with the durometer of first material 52 being different than the durometer of second material 54. Those of skill in the art will appreciate that first material 52 and second material 54 may be different materials without deviating from the spirit and scope of the present invention. First material 52 and second material 54 may also have substantially the same durometer.

It is contemplated that controlling portions of the present invention may be implemented in either software or hardware, or a combination thereof. In a presently preferred embodiment, computer 90 is programmed to direct system 20 to perform a plurality of steps comprising a method in accordance with the present invention. In a presently most preferred embodiment, the program runs in conjunction with a WINDOWS NT operating system, and the program includes a graphical user interface (GUI). The operator may perform some operations, such as opening files, using procedures which are similar to the procedures used by other programs which run in WINDOWS NT. This provides operating ease with a minimum of training and takes advantage of the existing WINDOWS NT operation system structure.

The program may be called up by using mouse 116 to double click on the program icon. When the program is initialized, manual control screen 122 will appear on monitor 112.

In a presently preferred method, profile editor button 136 is actuated and profile editor screen 140 appears on monitor 112. In a method in accordance with the present invention, a first melt pump profile is entered into computer 90. The first melt pump profile is comprised of a plurality of desired first melt pump rotational velocity values, each paired with an extrusion distance value.

A second melt pump profile is also entered into computer 90. The second melt pump profile is comprised of a plurality of desired second melt pump rotational velocity values, each paired with an extrusion distance value. Additionally, a puller profile may be entered into the computer. The puller profile is comprised of a plurality of desired pulling velocity values, each paired with an extrusion distance value. Also, an air control profile may be entered into the computer. The air control profile is comprised of a plurality of voltage values, each paired with an extrusion distance value.

When the desired profiles have been created, the system user may return to manual control screen 122 by actuating the return button 146 on profile editor screen 140. The system user may start the operation of all axes by entering initial values and actuating the start all button. At this point, first melt pump 24 may begin pumping first material 52 into extrusion head 22. Likewise, second melt pump 26 may begin pumping second material 54 into extrusion head 22. An extrudate member 56 will be formed by first material 52 and/or second material 54. Extrudate member 56 will travel through cooling trough 58, or other forming device, puller 60, and cutter 62. While in the manual control mode, first melt pump 24, second melt pump 26, and puller 60 will each run at a substantially constant speed. The pressure controller 120 will also maintain the pressure inside a lumen defined by extrudate member 56 at a substantially constant level.

The system user may actuate run synchronized control button 138 to enter synchronous control screen 150. Once in synchronous control screen 150, the system user may set slide 152 to the run synchronous profile mode. When slide 152 is set to the “Run Synchronous Profile” mode, the system will begin running the profile for each axis. In a presently preferred embodiment, each profile will repeat itself in a continuous loop. Therefore, it is desirable that the starting value for each profile be equal to that profile's ending value.

First material 52 and second material 54 will be extruded from the extrusion head 22 to form a portion of extrudate member 56. The distance of extrudate member 56 passing through puller 60 will be measured utilizing puller encoder 106, I/O unit 80, and computer 90.

Computer 90 will determine the desired first melt pump rotational velocity value corresponding to the measured extrusion distance value in the first melt pump rotational velocity profile. The speed of the first melt pump will be adjusted so that it is substantially equal to the desired first melt pump rotational velocity value.

Computer 90 will determine the desired second melt pump rotational velocity value corresponding to the measured extrusion distance value in the second melt pump rotational velocity profile. The speed of the second melt pump will be adjusted so that it is substantially equal to the desired second melt pump rotational velocity value.

Computer 90 will determine the desired pulling velocity value corresponding to the measured extrusion distance value in the pulling velocity profile. The speed of the puller will be adjusted so that it is substantially equal to the desired pulling velocity value.

Computer 90 will determine the desired air control voltage value corresponding to the measured extrusion distance value in the air control profile. The air control voltage value will be adjusted so that it is substantially equal to the desired air control voltage value.

It may be appreciated from the above description that in a method in accordance with the present invention, the rotational velocity of the first melt pump, the rotational velocity of the second melt pump, the puller speed, and the air control voltage value are all synchronized with the extrusion distance value measured utilizing the puller encoder. It may also be appreciated the rotational velocity of the first melt pump, the rotational velocity of the second melt pump, the puller speed, and the air control voltage value may all vary relative to each other in any desired fashion.

Cutter 62 will be selectively actuated to cut extrudate member 56, forming lengths 64. Lengths 64 will drop onto conveyor 66. Conveyor 66 will carry lengths in a distal direction. Fluid may be selectively excreted from first blow off nozzle 72 to urge selected lengths 64 into first bin 74. Likewise, fluid may be selectively excreted from second blow off nozzle 82 to urge selected lengths 64 into second bin 84.

It should be understood that steps may be omitted from this process and/or the order of the steps may be changed without deviating from the spirit or scope of the invention. Having thus described the preferred embodiments of the present invention, those of skill in the art will readily appreciate that yet other embodiments may be made and used within the scope of the claims hereto attached.

Numerous advantages of the invention covered by this document have been set forth in the foregoing description. It will be understood, however, that this disclosure is, in many respects, only illustrative. Changes may be made in details, particularly in matters of shape, size, and arrangement of parts, without exceeding the scope of the invention. The invention's scope is, of course, defined in the language in which the appended claims are expressed.

What is claimed is:

1. A method of controlling a catheter tubing forming process using a personal computer, the method comprising the steps of:
(a) providing a system including:
a first melt pump in fluid communication with an extrusion head;
a second melt pump in fluid communication with the extrusion head;
first and second material sources in fluid communication with the first and second melt pumps respectively;
a polyether block amide having a first durometer disposed in the first material source;
a polyether block amide having second durometer disposed in the second material source;
the first durometer being substantially greater than the second durometer;
a puller arranged to receive extrudate emerging from the extrusion head;
a first drive coupled to the first melt pump;
a second drive coupled to the second melt pump;
a third drive coupled to the puller;
a cutter;
a fourth drive coupled to the cutter, the first, second, third and fourth drives being coupled to a drive controller;
a motion control unit coupled to the drive controller;
an encoder coupled to the third drive, and being adapted to measure the length of extrudate passing through the puller;
a personal computer operating on a Windows NT operating system coupled to the drive controller and the motion control unit; and
a mouse, a keyboard and a monitor coupled to the personal computer;
(b) initializing a program in the personal computer to display a manual control screen;
(c) entering a first melt pump profile into the computer, wherein the first melt pump profile is comprised of a plurality of desired first melt pump rotational velocity values each paired with an extrusion distance value;
(d) entering a second melt pump profile into the computer, wherein the second melt pump profile is comprised of a plurality of desired second melt pump rotational velocity values each paired with an extrusion distance value;
(e) extruding material from the extrusion head to form an extrudate member;
(f) monitoring an extrusion distance value;
(g) determining the desired first melt pump rotational velocity value corresponding to the measured extrusion distance value in the first melt pump rotational velocity profile;
(h) adjusting the speed of the first melt pump so that it is substantially equal to the desired first melt pump rotational velocity value;
(i) determining the desired second melt pump rotational velocity value corresponding to the measured extrusion distance value in the second melt pump rotational velocity profile; and
(j) adjusting the speed of the second melt pump so that it is substantially equal to the desired second melt pump rotational velocity value.
